(19) United States
(12) Patent Application Publication
(10) Pub. No.: US 2026/0043422 A1
(43) Pub. Date: Feb. 12, 2026

(54) Energy Storage and Control System for Pipeline Flow Control

(71) Applicant: Emerson Process Management Valve Automation Inc., Houston, TX (US)

(72) Inventors: Jason Hoffbauer, Upper Sandusky, OH (US); John Carroll, Mansfield, OH (US); Jamie Lorentz, Houston, TX (US)

(21) Appl. No.: 19/099,973

(22) PCT Filed: Aug. 9, 2023
(86) PCT No.: PCT/US2023/071939

§ 371 Date: Jan. 30, 2025

Related U.S. Application Data
(60) Provisional application No. 63/396,439, filed on Aug. 9, 2022.
(60) Provisional application No. 63/492,389, filed on Mar. 27, 2023.
(60) Provisional application No. 63/492,397, filed on Mar. 27, 2023.

(51) Int. Cl. F15B 1/027; F15B 1/08; F16K 31/124

(52) U.S. Cl. CPC F15B 1/027; F15B 1/08; F16K 31/124

(57) ABSTRACT

A fluid control system for controlling flow of a process fluid can include an actuator and an energy storage system. The actuator can be configured to actuate a valve to control the flow of the process fluid and the energy storage system can drive the actuator. The energy storage system can include an accumulator in fluid communication with the actuator and a manual pump configured to charge the accumulator.

### CROSS-REFERENCE TO RELATED APPLICATION

This application claims priority to U.S. Provisional Application Nos. 63/396,439, filed Aug. 9, 2022, 63/492,389, filed Mar. 27, 2023, and 63/492,397, filed Mar. 27, 2023, the entireties of which are incorporated herein by reference.

### BACKGROUND

Fluid control systems can be used in a variety of industrial, commercial, and other settings to regulate, protect, isolate, or maintain pipes, conduits, or other vessels and the flow of fluid therein. In some applications, it may be useful to manage or control fluid flow in process systems where certain power sources are unavailable.

### SUMMARY

Some embodiments of the disclosure provide a fluid control system for controlling flow of a process fluid through a pipeline. The fluid control system can include a valve, an actuator, and an energy storage system. The valve can be moved between an open and closed position to control the flow of the process fluid through a section of the pipeline. The actuator can be configured to move the valve between the open and closed positions. The energy storage system can be in fluid communication with the actuator to drive the actuator. The energy storage system can include a single accumulator and a pump. The single accumulator can have a first chamber and a second chamber. The first chamber can be in fluid communication with the actuator and the second chamber can be in fluid communication with the pipeline so that the second chamber can receive pressurized process fluid from the pipeline. The pump can be configured to pump hydraulic fluid into the first chamber of the single accumulator to charge the single accumulator against the pressure of the pressurized process fluid in the second chamber. The energy storage system can define a fully charged state and a fully discharged state. In the fully charged state, the first chamber of the single accumulator can include a maximum operational volume of the hydraulic fluid and the second chamber can include a minimum operational volume of the pressurized process fluid. At a fully discharged state, the first chamber of the single accumulator includes a minimum operational volume of hydraulic fluid and the second chamber includes a maximum operational volume of the pressurized process fluid.

In some embodiments, a fluid control system can include a manual pump that is operatable by hand without electricity.

In some embodiments, a fluid control system can include an energy storage system. The energy storage system can include a pump that is in fluid communication with an actuator and a fluid reservoir. Operation of the pump can place the energy storage system in a charging state in which the pump pumps hydraulic fluid from the fluid reservoir into a first chamber a single accumulator.

In some embodiments, a fluid control system can include an energy storage system that defines a discharging state. In the discharging state, hydraulic fluid can flow from a first chamber of a single accumulator to an actuator and pressurized process fluid can flow from a pipeline into a second chamber of the accumulator.

In some embodiments, a fluid control system can include a directional control valve to direct hydraulic fluid from a first chamber of a single accumulator to an actuator to move the actuator in a first direction and to direct hydraulic fluid from the first chamber of the single accumulator to the actuator to move the actuator in a second direction.

In some embodiments, a fluid control system can include an actuator. Moving the actuator in a first direction can open a valve and moving the actuator in a second direction can close the valve.

In some embodiments, a fluid control system can include an actuator. Moving the actuator in a first direction and moving the actuator in a second direction can provide a valve event. A single accumulator can be configured to supply flow for fewer than two valve events before arriving at a fully discharged state.

In some embodiments, a fluid control system can include an actuator. Moving the actuator in a first direction and moving the actuator in a second direction can provide a valve event. A single accumulator can be configured to provide flow for at least three valve events before arriving at a fully discharged state.

In some embodiments, a fluid control system can include hydraulic fluid that is contained within a first flow system and process fluid that is contained within a second flow system that is fluidically closed to the first flow system.

In some embodiments, a fluid control system can include a portable pump in parallel with a main pump. The portable pump can be configured to pump hydraulic fluid to a first chamber of a single accumulator to charge the single accumulator against pressure of pressurized process fluid in a second chamber of the single accumulator.

In some embodiments, a fluid control system can include an energy storage system that permits a single accumulator to transition from a fully charged state to a fully discharged state without operation of a pump.

Some embodiments provide an energy storage system for driving an actuator. The actuator can be configured to move a valve between open and closed positions to control flow of a process fluid through a section of a pipeline. The energy storage system can include an accumulator having a first chamber and a second chamber. The first chamber can be in fluid communication with the actuator and the second chamber can be in fluid communication with the pipeline so that the second chamber can receive pressurized process fluid from the pipeline. A manual pump can be configured to pump hydraulic fluid into the first chamber of the accumulator to charge the accumulator against the pressure of the pressurized process fluid in the second chamber.

Some embodiments provide an energy storage system for driving an actuator. The actuator can be configured to move a valve between open and closed positions to control flow of a process fluid through a section of a pipeline. The energy storage system can include a vessel that defines an internal chamber in fluid communication with the actuator and pump. The pump can be configured to charge the vessel with a control fluid against pressure applied by the process fluid. A second can be configured to sense a fluid level of the control fluid within the vessel and signal whether the control fluid is at a maximum operation volume. The maximum operational volume can be less than the total volume of the internal chamber of the vessel.

In some embodiments, an energy storage system can include an accumulator or other vessel that is not arranged to operate in parallel with another accumulator or other vessel.

In some embodiments, an energy storage system can include a manual pump that is configured to pump hydraulic fluid into a vessel to charge the vessel against pressure of a process fluid. Operation of the manual pump can place the vessel in a charging state in which the pump pumps hydraulic fluid from a fluid reservoir into the vessel.

In some embodiments, an energy storage system can include a vessel that is in a discharging state when hydraulic fluid flows from the vessel to the actuator and pressurized process fluid flows from the pipeline into the vessel.

In some embodiments, an energy storage system can include a directional control valve to direct hydraulic fluid from a first chamber of a vessel to an actuator to move the actuator in a first direction and to direct hydraulic fluid from the first chamber of the vessel to the actuator to move the actuator in a second direction.

In some embodiments, an energy storage system can include process fluid that is fluidically separated from the hydraulic fluid.

In some embodiments, an energy storage system can include a vessel that is a single accumulator (e.g., not two accumulators in parallel). In some embodiments, the energy storage system can include only a single accumulator (i.e., can not include multiple accumulators, nor multiple accumulator volumes or chambers arranged for parallel operation within in a device or system).

Some embodiments provide a method of actuating a valve of a pipeline for a process fluid. The method can include charging an accumulator. Charging the accumulator can include manually pumping a control fluid from a fluid reservoir to charge a first chamber of the accumulator with the control fluid. The accumulator can be thereby charged so as to be discharged to drive an actuator of a valve via a flow of the control fluid out of the first chamber, and powered by a pressure of process fluid within the pipeline.

In some embodiments, a method of actuating a valve of a pipeline for a process fluid can include discharging an accumulator. Discharging the accumulator can include signaling hydraulic fluid to flow from a first chamber of the accumulator to an actuator and sending the process fluid from the pipeline into a second chamber of the accumulator. Discharging the accumulator does not include operating a pump.

### BRIEF DESCRIPTION OF THE DRAWINGS

The accompanying drawings, which are incorporated in and form a part of this specification, illustrate embodiments of the inventive subject matter and, together with the description, serve to explain the principles of embodiments of the disclosure:

FIG. 1 is a schematic view of a fluid control system according to an embodiment of the disclosure, the fluid control system including an actuator, an accumulator, and a pump.

FIG. 2 is a schematic view of the fluid control system of FIG. 1 in a charging state.

FIG. 3 is a schematic view of the fluid control system of FIG. 1 in a discharging state.

FIG. 4 is a schematic view of a fluid control system according to an embodiment of the disclosure, the fluid control system including an actuator, an accumulator, and a battery-operated pump.

FIG. 5 is a schematic view of a fluid control system according to an embodiment of the disclosure, the fluid control system including an accumulator and a motor control arrangement.

FIG. 6 is a cross-sectional side view of the accumulator of FIG. 5.

FIG. 7 is a schematic view of a fluid control system according to another embodiment of the disclosure, the fluid control system including an accumulator and a motor control arrangement.

FIG. 8 is a cross-sectional side view of the accumulator of FIG. 7.

FIG. 9 is a schematic view of a fluid control system according to another embodiment of the disclosure, the fluid control system including a vessel, a motor, and a motor control arrangement.

FIG. 10A illustrates a schematic view of the vessel of FIG. 9 with a control fluid level below a maximum operational fluid volume and the motor running.

FIG. 10B illustrates a schematic view of the vessel of FIG. 9 with the control fluid level at a maximum operation volume and the motor stopped.

### DETAILED DESCRIPTION

The following discussion is presented to enable a person skilled in the art to make and use embodiments of the inventive subject matter. Given the benefit of this disclosure, various modifications to the illustrated embodiments will be readily apparent to those skilled in the art, and the principles herein can be applied to other embodiments and applications without departing from embodiments of the disclosure. Thus, embodiments are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments described herein. Skilled artisans will recognize the examples provided herein have many useful alternatives and fall within the scope of embodiments of the disclosure.

Before any embodiments are explained in detail, it is to be understood that the inventive subject matter is not limited in its application to the details of construction and the arrangement of components set forth in the following description or illustrated in the following drawings. The inventive subject matter is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As briefly discussed above, fluid control systems can be used in a variety of industrial, commercial, and other settings to control fluid flow through pipes, conduits, or other vessels. For example, some process systems, including off-shore drilling wells, oil fields, natural gas transmission pipelines, etc. may (occasionally) require valve actuation at remote or difficult to access sites. Such remote sites may lack a power source and thus would benefit from non-electric valve actuation.

Embodiments can provide a fluid control system having an energy storage system configured to actuate a valve. Some fluid control systems described herein can actuate a valve without electricity or other non-manual power sources. In particular, embodiments described herein can provide an energy storage system that includes a manually-operated pump configured to charge an accumulator, and in some embodiments, a single accumulator (i.e., without charging another accumulator in parallel or charging multiple accumulator chambers that are arranged for operation in parallel with each other within a device or system). The accumulator can be configured to store potential energy that can drive an actuator when a signal requesting a valve event is received. After a discharging event of the accumulator, the manual pump can be used to recharge the accumulator with a control fluid in preparation for another signaled valve event.

In general, adding energy to a system (e.g., via a motorized pump) can increase the thermal energy of a working or control fluid therein, which can cause thermal expansion and/or pressure variations in the fluid. Thus, in fluid control systems that employ a control fluid to charge (and discharge) an accumulator to drive an actuator, it is largely important to control, monitor, reduce, and/or eliminate thermal expansion within the system to help ensure a fully and completely charged state of the accumulator.

Other embodiments can provide a fluid control system having an energy storage system configured to be recharged by a motor or other energy supplier (e.g., a motorized pump) while compensating for thermal expansion. In particular, the energy storage system can include built-in thermal compensation. For example, the volume of hydraulic fluid (or other control fluid) can fluctuate based on temperature or pressure changes. Embodiments of the disclosure provide an energy storage system that compensates for thermal expansion of hydraulic fluid within a single vessel, such as a single accumulator. The energy storage system can include a motor control arrangement in communication with a motor. The motor control arrangement can send turn-on or shut-off signals to the motor depending on fluid level within the accumulator or vessel to recharge the accumulator or vessel with hydraulic fluid while maintaining a thermal compensation gap volume within the accumulator or vessel to prevent fluid overfill or device damage from over pressurization.

In general, it can be costly, time consuming, and inefficient to monitor and/or compensate for thermal expansion of a control fluid in conventional fluid control systems, especially using an external or secondary thermal volume controller. As a result, embodiments of the disclosure can address these and other drawbacks of conventional fluid control systems.

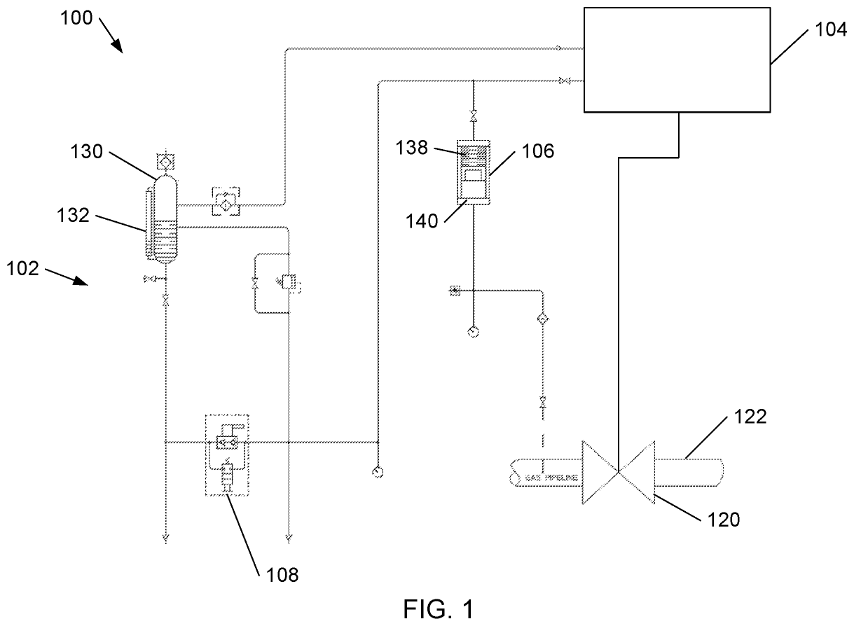

FIG. 1 illustrates a fluid control system 100 according to an embodiment of the disclosure. The fluid control system 100 can include an energy storage system 102 in communication with an actuator 104 (e.g., of various known types to open and close valves of various known types). In the illustrated embodiment, the energy storage system 102 can include an accumulator 106, and a pump 108. As installed for operation, the fluid control system 100 can be in communication with a valve, such as the valve 120 (e.g., a valve of any variety of known types to control shut-off of a relevant flow). In the illustrated configuration, the valve 120 is in fluid communication with a process fluid flowing through a pipeline 122. The valve 120 may be stroked via the actuator 104 to close (or open) the valve 120 and cause process fluid to cease flowing (or allow process fluid to flow) through the pipeline 122.

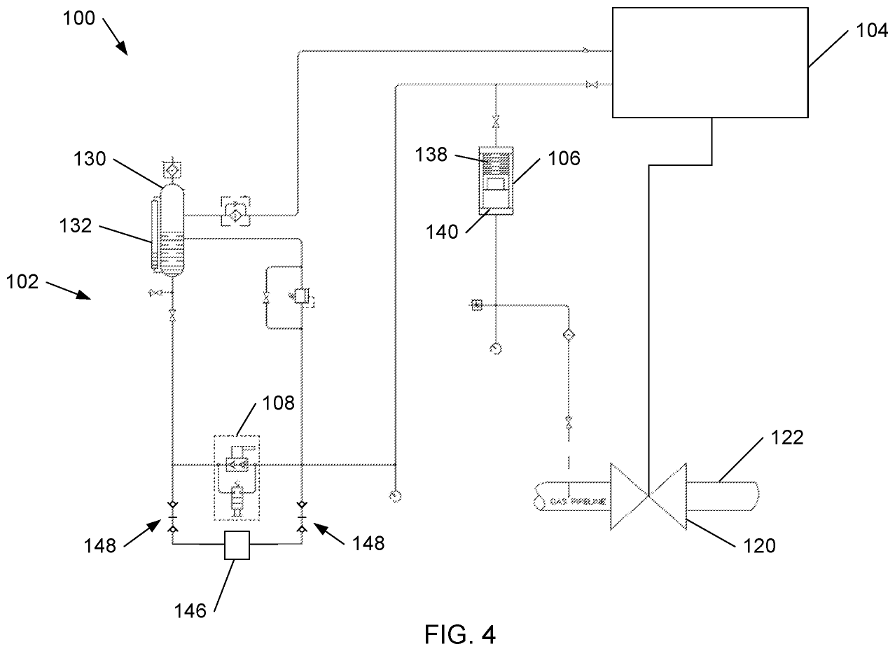

In some embodiments, the pipeline 122 can include a compressible fluid, such as natural gas, for example, that flows through the pipeline 122 at a high pressure. The pipeline 122 can be employed in a variety of process systems and sections of the pipeline 122 (e.g., including the valve 120) may be located in remote locations where a power source (e.g., electric or pneumatic) may be unavailable or costly to attain. In this regard, the fluid control system 100, according to embodiments of the disclosure, can generally operate without power and, in particular, without power to the pump 108. Thus, in some embodiments, the pump 108 is configured as a manual pump. However, other configurations are possible, including as described with respect to FIG. 4.

With continued reference to FIG. 1, the energy storage system 102 includes the accumulator 106, which may generally be configured as a vessel, in fluid communication with the pump 108. The energy storage system 102 can further include a fluid reservoir 130 (e.g., having a level viewer 132). In the illustrated embodiment, the fluid reservoir 130 is located upstream from the pump 108 and downstream from the actuator 104. In general, the fluid control system 100 provides a first closed-loop hydraulic system through which the control fluid travels. The energy storage system 102 within the fluid control system 100 can further include a series of valves, including a system bypass valve, relief valves, check valves, directional valves, and isolation valves, for example, as well as one or more oil filters, reservoir drains, and pressure gauges (e.g., not shown or numbered).

The energy storage system 102 can include a control fluid that can be transferred to and from the accumulator 106 and the reservoir 130 via the pump 108. In some embodiments, the control fluid can be hydraulic fluid, however, other non-compressible fluids are possible. In use, the pump 108, which in a preferred embodiment is a manual pump, can suction the control fluid from the fluid reservoir 130 and discharge the control fluid into a first chamber 138 of the accumulator 106. The accumulator 106 can also include a second chamber 140 opposite the first chamber 138 and fluidically separated from the first chamber 138 (e.g., via a piston or bladder). The second chamber 140 is configured to be filled with the (high pressure) process fluid from the pipeline 122. Thus, the second chamber 140 is in fluid communication with the pipeline 122 upstream of the valve 120 and provides a second flow system that is fluidically closed to the first system (i.e., as includes the first chamber 138, the pump 108, the reservoir 130, etc.).

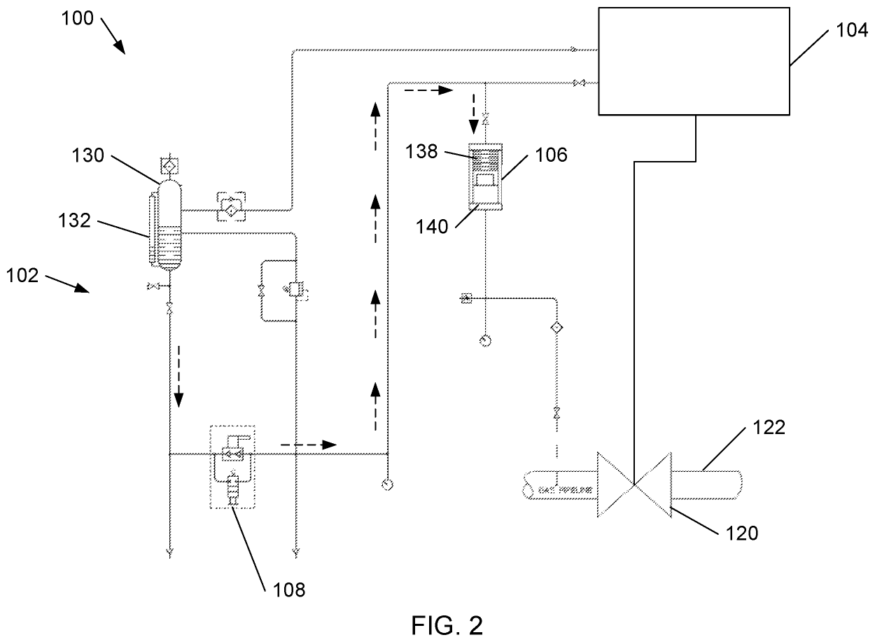

FIG. 2 illustrates a charging state of the energy storage system 102. In particular, as the control fluid is drawn from the fluid reservoir 130 via the pump 108, the accumulator 106 is charged against the gas pressure of the process fluid in the pipeline 122 (i.e., fluid is temporarily filled into the first chamber 138 against the pressure of the process fluid in the second chamber 140). As the control fluid fills the first chamber 138 of the accumulator 106, the potential energy stored in the accumulator 106 increases. When the accumulator 106 is in a fully charged state (i.e., at maximum potential energy), the first chamber 138 is at a maximum operational volume (i.e., a maximum fluid volume for the chamber 138 for any state of the accumulator 106 during service) and the second chamber 140 is at a minimum operational volume (i.e., a minimum fluid volume for the chamber 140 for any state of the accumulator 106 during service).

In general, the potential energy stored in the accumulator 106 can be used with a variety of actuator controls, including an actuator (e.g., the actuator 104) configured to stroke pipeline valves when no electric service is available. In the illustrated embodiment, the first chamber 138 of the accumulator 106 is also in fluid communication with the actuator 104. When a signal is received by the fluid control system 100, the accumulator 106 can release some (or all) of its potential energy to drive the actuator 104. The actuator 104 can then execute a particular valve event, such as closing or opening the valve 120. In some embodiments, a signal can be received by a directional control valve (not shown) of various known types that is part of or in fluid communication with the actuator 104. The control valve can direct fluid from the first chamber 138 of the accumulator 106 to the actuator 104.

In use, an operator may physically travel to the fluid control system 100 to manually operate the pump 108 of the energy storage system 102 to charge the accumulator 106 (i.e., to operate the pump 108 by the operator inputting mechanical energy directly to the fluid control system 100 or via the use of a powered or unpowered hand tool). As needed, the level viewer 132 can be used to gauge the volume of control fluid in the first chamber 138, and thus, the potential energy of the accumulator 106. For example, the level viewer 132 can indicate when the first chamber 138 is filled with the control fluid to the maximum operational volume, which can correspond to a fully charged state of the accumulator 106. In other embodiments, one or more of the accumulator 106 or the reservoir 130 can include additional or alternative gauges to monitor the state of the accumulator 106, such as a dipstick or other graduated measurement device.

As discussed above, the pump 108 of the present embodiment can be a manual pump. Among other benefits, use of a manual pump can reduce (e.g., eliminate) excess energy (i.e., heat) that may be added to the energy storage system 102 when the pump 108 charges the accumulator 106. For example, motorized or other non-manual pumps can increase thermal energy of a control fluid moving through such pumps, at least more substantially than is typical for manual pumps. However, thermal energy can be introduced into the system via other events, including change in ambient temperature. In this regard, one or more relief valves can be incorporated into the energy storage system 102 to compensate for volume and pressure changes in the control fluid.

In general, an increase in thermal energy of the control fluid can affect the pressure of the control fluid and negatively impact the potential energy of such control fluid that may be stored in an accumulator, for example. Correspondingly, use of a manual pump according to some embodiments of the disclosure can result in improved operational efficiency and energy storage capacity. Similarly, use of a manual pump can result in systems that require fewer or less complex components. For example, in some systems where thermal energy is increased in a control fluid via a non-manual pump, a thermal compensation device is used to compensate or otherwise adjust for pressure variations and other fluctuations in the fluid. Some embodiments can be efficiently operated without such thermal compensation devices, or at least with compensation systems having smaller volumes than with conventional designs.

Thus, embodiments of the disclosure can advantageously reduce (or eliminate) excess energy in the control fluid of the energy storage system 102 via the manual pump 108. In this regard, embodiments of the disclosure can provide a simplified energy storage system that does not require a thermal compensation device. In general, a thermal compensation device can include a variety of devices including, for example, a thermal compensation accumulator or a thermal volume controller. A thermal volume controller could include, for example, a pressure switch or a second accumulator (e.g., arranged fluidically in parallel with the accumulator 106). Such thermal compensation devices can add a variety of complications to a fluid control system, such as increased cost, maintenance, repairs, and complex installation. Additionally, embodiments can provide a fluid control system with an energy storage system that permits a single accumulator to transition from a fully charged state to a fully discharged state without operating a pump. In conventional fluid control systems, a sensor arrangement may trigger an electric pump during a discharge process, however, embodiments of the present disclosure allow operation of a pump that is independent of an actuator or other thermal volume controller.

In this regard, embodiments of the disclosure can advantageously provide an unbranched flow path between the second chamber 140 of the accumulator 106 and the pipeline 122. The unbranched flow path may not include flow to other operational devices of the energy storage system 102, such as a second accumulator, for example. However, the unbranched flow path, as designated by the path extending between the second chamber 140 of the accumulator 106 and the pipeline 122 in FIGS. 1-4, may include non-operational components, such as filters or gauges, for example. In some embodiments, an unbranched flow path may be characterized by a series (i.e., not parallel) flow path extending between the second chamber 140 and the pipeline 122. Other non-operational components may include components that, if removed from the system 100, would not affect the fundamental operation of the energy storage system 102.

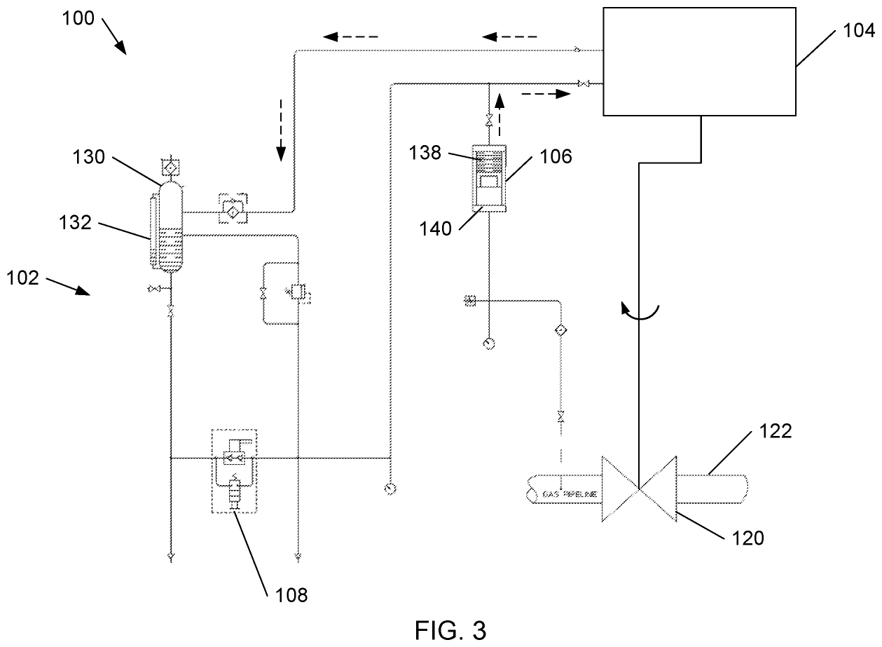

Turning now to FIG. 3, a discharging state of the energy storage system 102 is illustrated. During operation in the discharging state, one or more valves can permit flow out of the first chamber 138, as powered by pipeline pressure via the second chamber 140 filling with the pressurized process fluid from the pipeline 122. This flow into the second chamber 140 forces the control fluid from the first chamber 138 of the accumulator 106 toward the actuator 104, and the actuator 104 can correspondingly initiate and complete a valve stroke on the valve 120. Generally, thus, during the discharging state, some (or all) of the potential energy stored in the accumulator 106 is released. In some implementations, a discharge of the accumulator 106 to power a valve event (or events) can result in the accumulator 106 being discharged to a fully discharged state. When the accumulator 106 is in a fully discharged state (i.e., a minimum or zero potential energy), the first chamber 138 is at a minimum operational volume and the second chamber 140 is at a maximum operational volume. In some cases, however, an accumulator may not be fully discharged by operation during a valve event (or events).

In some embodiments, the accumulator 106 may allow multiple discharge events, such that the accumulator can drive the actuator 104 multiple times (i.e., to stroke the valve 120 multiple times) before requiring a recharge from the pump 108. For example, in some embodiments, the actuator 104 can include a directional control valve (not shown) that directs the control fluid from the first chamber 138 of the accumulator 106 to move or stroke the actuator 104 in a first direction (e.g., clockwise) or direct the control fluid from the first chamber 138 of the accumulator 106 to move or stroke the actuator 104 in a second direction (e.g., counterclockwise). Thus, in some embodiments, the accumulator 106 may be configured to partially discharge to close the valve 120, partially discharge to open the valve 120, and fully discharge to close the valve 120 (or otherwise similarly operate over multiple valve events).

Though it should be appreciated that the accumulator 106 and fluid control system 100 may be configured to stroke or otherwise actuate the valve 120 one time or a plurality of times, in a preferred embodiment, the accumulator 106 may be configured to drive the actuator 104 an odd number of times (e.g., 1 or 3 times). For example, the fluid control system 100 may be used to close a valve or otherwise restrict flow through the pipeline 122 in an instance of failure or other unwanted event associated with the process fluid and the pipeline 122. Given that the fluid control system 100 may be employed in a remote or non-easily accessible location, it would be generally useful for the accumulator 106 to at least drive the actuator 104 to actuate the valve 120 to a safe (e.g., closed) orientation before the accumulator 106 requires a recharge. Thus, in a preferred embodiment, the energy storage system 102 is configured to close the valve 120 before reaching a fully discharged state, or, for example, close-open-close the valve 120 before being fully discharged.

FIG. 4 illustrates another example configuration of the fluid control system 100 according to embodiments of the disclosure. In the illustrated configuration, the energy storage system 102 can include a secondary power source 146. For example, in some embodiments, the secondary power source 146 may be configured as a battery-powered pump (e.g., a portable pump). The secondary power source 146 can include (or otherwise be powered by) a variety of sources, including a battery such as a truck battery, a battery-powered drill, or other portable batteries that can be used to drive a pump to charge the accumulator 106. In general, the secondary power source 146 may be a portable power source that an operator transports to the fluid control system 100 in a remote location. The secondary power source 146 may be connected to the fluid control system 100 via a quick-connect system 148 that allows for easy connection and disconnection between the secondary power source 146 and the fluid control system 100. For example, quick-connect valves or fittings of various known types can be arranged in communication with the hydraulic system so that the secondary power source 146 (e.g., a pump) can be readily and temporarily connected in parallel with the manual pump 108.

In some embodiments, the secondary power source 146, which can include a battery-powered pump, may be removable from the energy storage system 102. Such pump may be brought to the remote site of the fluid control system 100 when the accumulator 106 needs to be recharged, and removed when the accumulator 106 is charged. In this regard, the secondary power source 146 may be inserted into the fluid control system 100 in parallel with the manual pump 108. In other embodiments, the manual pump 108 may be in communication with a battery to provide a battery-powered pump. Still, in other embodiments, the secondary power source 146 may replace the manual pump 108 such that the manual pump 108 is removed from the fluid control system 100.

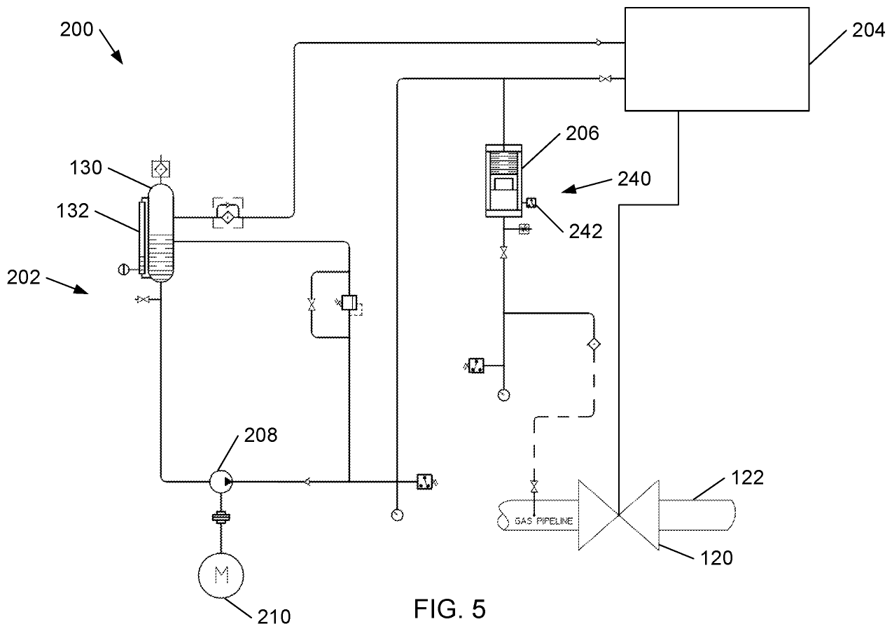

With reference to FIGS. 5-10B, other example configurations of (and for) a fluid control system 200 according to embodiments of the invention are shown. Similar to the fluid control system 100 described above, the fluid control system 200 can include an energy storage system 202 in communication with an actuator 204. The energy storage system 202 can include a vessel, such as an accumulator (as further discussed below), a pump 208, and a motor 210. By way of example, the fluid control system 200 can be in communication with a valve, such as the valve 120 within the pipeline 122. The valve 120 can be stroked via the actuator 204 to close (or open) the valve 120 and affect the flow of process fluid through the pipeline 122.

In some examples, the fluid control system 200 can include a thermal volume controller configured as a motor control arrangement 240. In some examples, the thermal volume controller can ensure that the energy storage system 202 is fully charged or otherwise appropriately filled with a control fluid during a recharging operation. For example, the thermal volume controller can operate a switch (e.g., an electric switch) based on fluid level or piston position to activate and deactivate the motor 210 and the pump 208 that fills or charges a vessel (e.g., a tank or accumulator) with a control fluid.

Furthermore, in some examples, the thermal volume controller may compensate (i.e., adjust, as needed) for pressure variations or fluctuations in the process fluid pipeline 122. As a result, unlike conventional electro-hydraulic systems, the example thermal volume controller disclosed herein can eliminate the need for pressure switches to operate a motor or pump. Conventional pressure switches can require re-calibration or re-adjustment as pressure of process fluid changes or fluctuates in the pipeline. In contrast, example thermal volume controllers described herein may not require any adjustment because they can automatically adjust to compensate for pressure fluctuations of the process fluid in the pipeline. Additionally, the example thermal volume controller disclosed herein may compensate for thermal expansion or pressure variations of a control fluid of the example control fluid power apparatus due to temperature variations (e.g., diurnal temperature variations).

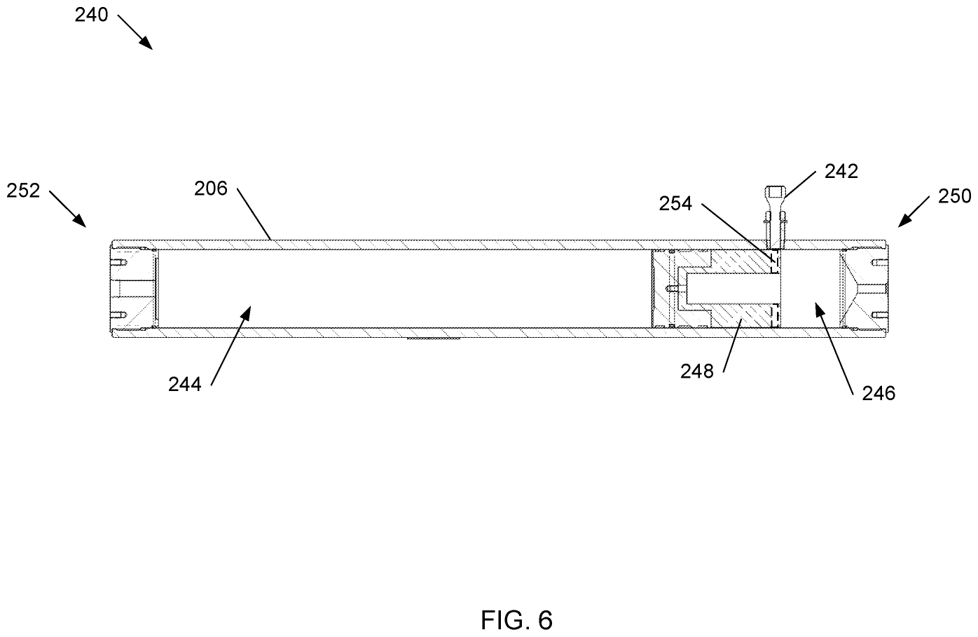

FIG. 5 illustrates one example configuration of the fluid control system 200. In this example, the energy storage system 202 includes an accumulator 206 in communication with the motor control arrangement 240. The motor control arrangement 240 of FIG. 5 can include a sensor, e.g., configured as a switch 242. In the illustrated example, the switch 242 is positioned near a bottom of the accumulator 206. The switch 242 can be connected (e.g., threaded) at or through a wall of the accumulator 206. As described above with respect to the accumulator 106 of FIGS. 1-4, the accumulator 206 can similarly include a first chamber 244 and a second chamber 246 that are fluidically separated by a barrier (e.g., a piston 248, as shown in FIG. 6).

In general, the pump 208, which can be connected to the motor 210, can suction control fluid from the fluid reservoir 130 and discharge the control fluid into the first chamber 244 of the accumulator 206. The first chamber 244, the pump 208, and the reservoir 130 can form part of a first flow system. The second chamber 246 of the accumulator 206 is configured to be filled with process fluid from the pipeline 122 and is isolated (e.g., by the piston 248) from the first chamber 244. Thus, the second chamber 246 provides a second flow system that is fluidically closed to the first flow system.

The switch 242 can be configured to send a signal to the motor 210 to turn on the motor 210 and thereby send fluid from the fluid reservoir 130 to the first chamber 244, or turn off the motor 210 and thereby stop the pump 208 from running so that fluid is not moved by the pump 208 from the fluid reservoir 130 to the first chamber 244. In some examples, the switch 242 may include sensors that can sense the position of the piston 248 (and thereby, indirectly, the control fluid level) within the accumulator 206. For example, if the switch 242 senses the piston 248 in a position that corresponds to a non-maximum operational volume of control fluid in the first chamber 244 (e.g., if the switch 242 is not triggered), the switch 242 can run the motor 210 to send fluid to the first chamber 244. Correspondingly, if the switch 242 senses the piston 248 in a position that corresponds to a maximum operational volume of control fluid in the first chamber 244 (e.g., if the switch 242 is triggered), the switch 242 can signal for the motor 210 to turn off (or to remain off).

The maximum operational volume of control fluid in the first chamber 244 can correspond to a maximum volume of control fluid within the first chamber 244 minus a compensation volume for the first chamber 244. For example, the accumulator 206 can be configured with a maximum operational volume large enough to retain a volume of control fluid that can provide sufficient potential energy to the actuator 204 to stroke the valve 120 open or closed, but with further volume (i.e., the compensation volume) that is available in the accumulator to allow appropriate thermal expansion of the control fluid. Thus, in some examples, the size of a compensation volume can be flexibly selected for a particular accumulator via selection of a particular set point for the maximum operational volume (e.g., by arranging the switch 242 for activation at a more or less advanced position of the piston 248).

In some examples, the stored potential energy corresponding to the maximum operational volume may be sufficient to stroke the valve 120 multiple times before recharging the accumulator 206 with the control fluid. The compensation volume can thus, in some examples, be formed by a gap that can provide thermal compensation within the energy storage system 202 when the control fluid is at the maximum operational volume. In this regard, the maximum operational volume of control fluid may be less than the maximum volume of the first chamber 244, so that the resulting compensation volume can allow for any expansion (or related change in characteristic) of the control fluid without damaging the accumulator 206 or affecting the potential for the accumulator 206 to energize the actuator 204 to stroke the valve 120.

In general, the compensation volume can protect the fluid control system 200 against over-pressurization and can be integrated within the accumulator 206. Accordingly, in some cases only a single accumulator may be needed in the fluid control system 200 (e.g., the accumulator 206, having a thermal volume controller configured as the motor control arrangement 240). In other words, the thermal compensation within the fluid control system 200 can occur in series with (e.g., within) the accumulator 206, as opposed to a parallel arrangement used in conventional approaches.

In some embodiments, the fluid control system 200 can further include a vent system fluidically disposed between the accumulator 206 and the valve 120. The vent system can, for example, be used when doing maintenance on the fluid control system 200 to bleed off any excess pressure from the working fluid. The vent system can be used effectively when there is a maximum volume of control fluid in the first chamber 244 so that there is a minimum volume of fluid that would need to be vented or depressurized in the second chamber 246.

FIG. 6 illustrates one example configuration of the accumulator 206 equipped with the thermal volume controller configured as the motor control arrangement 240. As shown in FIG. 6, the switch 242 is disposed near one end 250 of the accumulator 206, adjacent to the second chamber 246. In use, as the piston 248 moves from one end 250 of the accumulator 206 to the other end 252 of the accumulator, the switch 242 can control the motor 210 based on the position of the piston 248 (e.g., turning the motor 210 off when the piston 248 is nearer the first end 250 and the control fluid is at the maximum operational volume and turning the motor 210 on when the piston 248 is nearer the other end 252 and the control fluid is below the maximum operational volume). In some embodiments, the piston 248, the piston head, the piston rod, or other components that are stationary relative to the piston 248 (i.e., components that move with the piston), can include a complementary switch activator or target 254 that moves relative to the switch 242 to activate or deactivate the motor 210, and thus, the pump 208. In some embodiments, the switch 242 (and the target 254) can be configured as a magnet sensing switch or other linear distance switch or sensor.

By way of example, the complementary target 254 that is sensed by the switch 242 can include a ferrous or magnetic material and the switch 242 can be configured as a proximity switch. Therefore, activation or deactivation of the switch 242 can occur without direct engagement of the complementary target 254 with the switch 242. For example, the piston 248 may activate or deactivate the motor 210 when the target is in proximity relative to the switch 242 without directly engaging or contacting the switch 242.

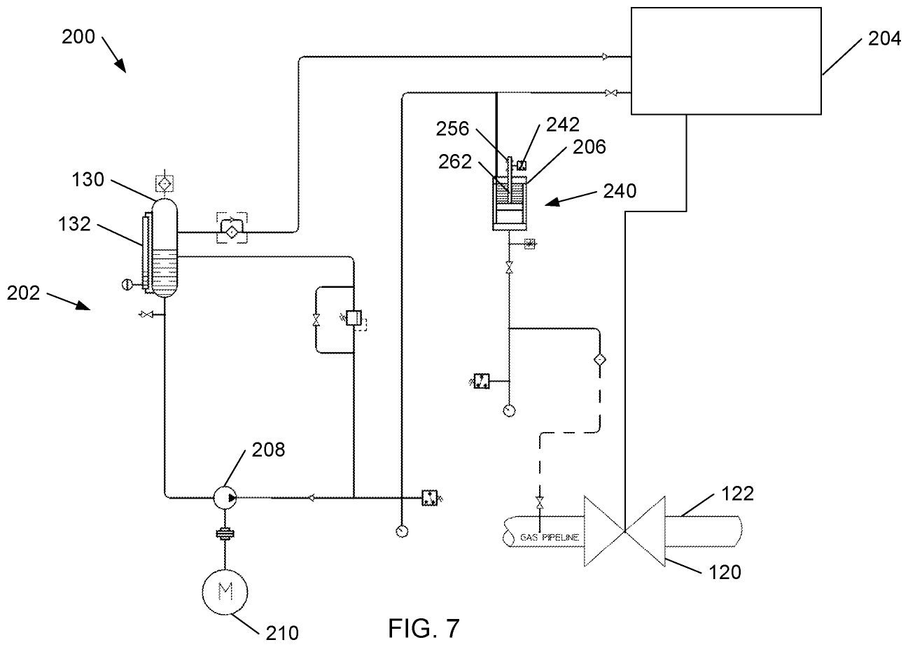

FIG. 7 illustrates another example configuration of the fluid control system 200. Similar to the configuration shown in FIG. 5, the configuration shown in FIG. 7 can include the motor control arrangement 240 with the switch 242, but the switch 242 can be differently arranged than in the example of FIG. 5. In particular, the switch 242 can be fixed to a switch rod 256 that is fixed relative to the accumulator 206 and extends into the accumulator 206. The piston 248 can include a target 254 fixed relative to the piston rod 262 so that the target 254 moves with the piston 248. The switch 242 and target 254 arrangement can thus sense the relative position of the piston within the accumulator 206. For example, if the switch 242 senses the piston 248 in a position that corresponds to a non-maximum operation volume of the control fluid, the switch can signal the motor 210 to run. Correspondingly, if the switch 242 senses the piston 248 in a position that corresponds to a maximum operational control volume of control fluid in the accumulator 206, the switch 242 can signal the motor 210 to turn off (or remain off).

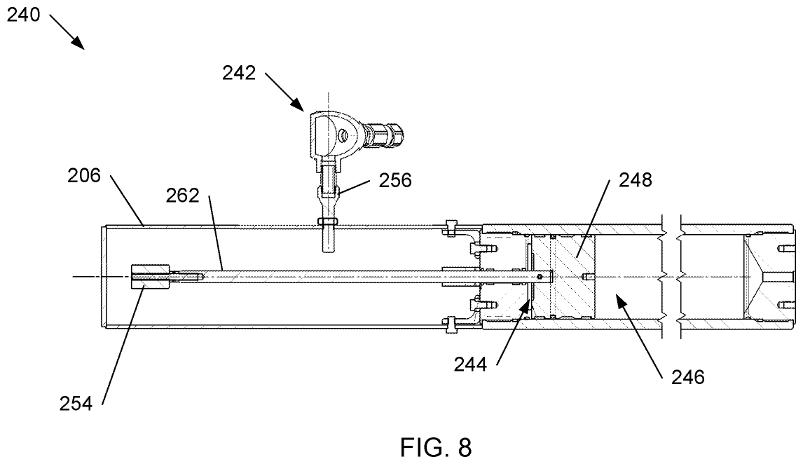

FIG. 8 illustrates one example configuration of the accumulator 206 of FIG. 7 equipped with the thermal volume controller configured as the motor control arrangement 240. In the illustrated configuration, the motor control arrangement 240 includes the switch 242 fixed to the switch rod 256 and the target 254 fixed to the piston rod 262. As shown, the piston rod 262 extends through the first chamber 244 and is opposite the piston 248 from the second chamber 246. The motor control arrangement 240 can thus provide thermal compensation in series with (and integrated within) the accumulator 206 by activating or deactivating the motor to start and stop according to the maximum operational volume of the control fluid and a prescribed compensation volume (e.g., gap) within the accumulator 206 based on a position of the piston 248.

In some embodiments, the prescribed compensation gap may vary based on a variety of factors of the fluid control system 200 and its environment. For example, these factors can include control fluid type, working fluid type, maximum working fluid pressure, accumulator size (e.g., capacity), valve stroke requirements, ambient temperature, and altitude. Thus, compensation gap may be adjusted to provide sufficient compensation based one or more internal or external system factors and can vary in size (e.g., volume) for different configurations. By way of example, in some configurations, the compensation gap may be dimensioned to compensate for temperature variations of 100° F. and the associated thermal expansion of the control fluid.

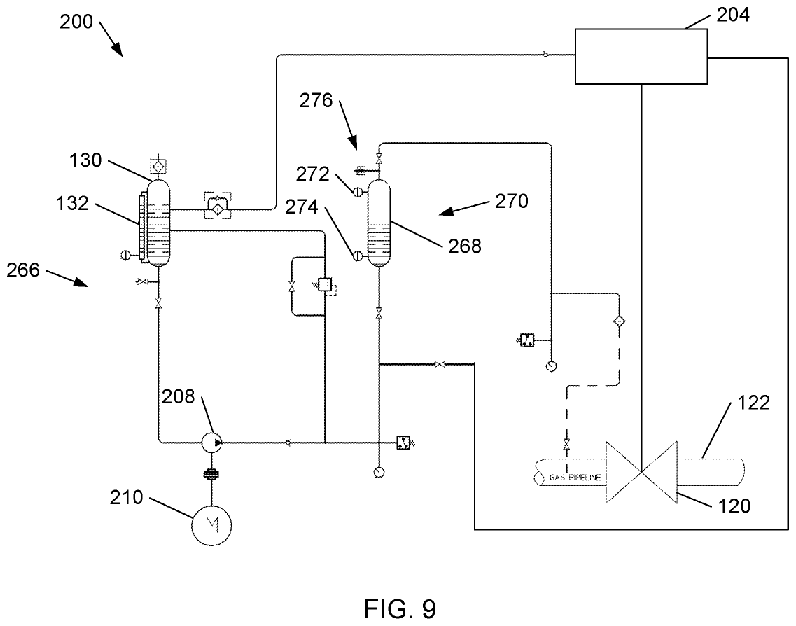

FIG. 9 illustrates another example configuration of the fluid control system 200. The fluid control system 200 shown in FIG. 9 includes the energy storage system 266. The energy storage system 266 includes a vessel 268 in fluid communication with the pump 208 and with the pipeline 122. The vessel 268 can thus be charged against the gas pressure of the process fluid in the pipeline 122. As the control fluid fills the vessel 268, the potential energy stored in the vessel 268 increases. When the vessel 268 is fully charged, the control fluid is at a maximum operational volume.

The fluid control system 200 can be equipped with a thermal volume control integrated with the vessel 268 via a motor control arrangement 270. Similar to the thermal volume control described above, the motor control arrangement 270 can include a switch 272 to activate and deactivate the motor 210 and the pump 208 that fills the vessel 268 with control fluid. The motor control arrangement 270 can provide a thermal volume controller that can adjust to compensate for pressure or volume fluctuations in the control fluid or the process fluid within the pipeline 122.

The switch 272, for example, can be configured as a motor stop level switch and can be positioned near a top 276 of the vessel 268. When a fluid level reaches a predetermined height in the vessel, the motor 210 can be signaled to turn off via the switch 272. Correspondingly, if the fluid level is below a predetermined threshold, the motor 210 can run to charge the vessel 268. In some embodiments, the switch 272 can be configured as a fork level switch, such as a vibrating fork. In use, for example, if the level switch senses fluid between arms of the fork, then the motor can be turned off. Correspondingly, if the level switch does not sense fluid between the arms of the fork, then the motor can be turned on.

The vessel 268 can further include a secondary switch 274. The secondary switch 274 is optional in the fluid control system 200 and can be configured as a low level switch. The secondary switch 274 can be used to tell a user when the control fluid within the vessel 268 is low. Additionally or alternatively, the secondary switch 274 could be used as a backstop to prevent an attempted stroke from the actuator 204 if the control fluid is too low and the vessel 268 is not sufficiently charged to complete a full valve stroke (or other desired operation). In one example, the secondary switch 274 can be used to confirm a deenergized or depressurized state of the vessel 268 during a maintenance procedure.

In some embodiments, the vessel 268 can further include an internal bladder that fluidically separates the control fluid from the working fluid of the pipeline 122. However, in contrast, in some embodiments, the control fluid may not be separated from the working fluid from the pipeline 122. In this regard, the physical location (e.g., height) of the sensor is important to provide a compensation gap within the vessel 268 to accommodate for volume changes, including foaming interactions between the control fluid and the working fluid.

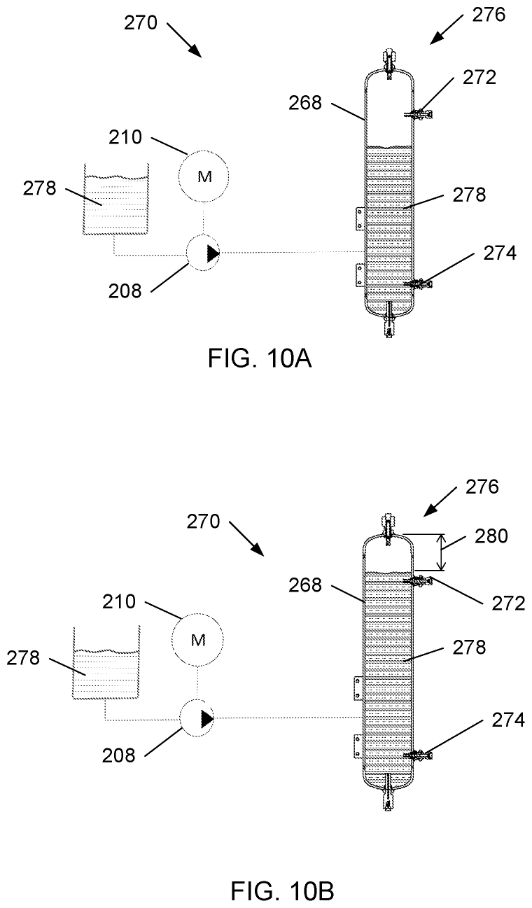

FIGS. 10A and 10B illustrate example states of the vessel 268 in the fluid control system 200. FIG. 10A illustrates a state in which the control fluid 278 is below the sensor threshold measured by the switch 272 and the motor 210 is active (e.g., running) to pump control fluid into the vessel 268. In contrast, FIG. 10B illustrates a state in which the control fluid is at or above the sensor threshold measured by the switch 272 and the motor 210 is deactivated (e.g., not running) so that control fluid 278 is no longer being pumped into the vessel 268. The control fluid 278 shown in FIG. 10B is thus at a maximum operational volume (in some examples).

Furthermore, FIG. 10B, which shows a state in which the motor 210 is stopped, illustrates a compensation gap 280 (e.g., a compensation volume) within the vessel 268. The compensation gap 280 can provide thermal compensation, as described above, which can compensate or otherwise adjust for pressure and volume variations or fluctuations in the fluid. The sum of the maximum operational volume of the control fluid and the compensation gap can be the total capacity of the vessel 268. Notably, the thermal compensation (via the compensation gap 280) occurs in series (and within) the vessel 268 so that additional, external, or parallel thermal compensation is not needed. In general, external or parallel thermal compensation can increase costs, maintenance, repairs and complicate installation.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive. For a path that is not linear, the path can be considered to be substantially parallel to a reference direction if a straight line between end-points of the path is substantially parallel to the reference direction or a mean derivative of the path within a common reference frame as the reference direction is substantially parallel to the reference direction.

Also as used herein, unless otherwise limited or defined, “substantially perpendicular” indicates a direction that is within ±12 degrees of perpendicular a reference direction (e.g., within ±6 degrees), inclusive. For a path that is not linear, the path can be considered to be substantially perpendicular to a reference direction if a straight line between end-points of the path is substantially perpendicular to the reference direction or a mean derivative of the path within a common reference frame as the reference direction is substantially perpendicular to the reference direction.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±30%, inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1-15. (canceled)

16. A fluid control system comprising:
an actuator configured to move a valve between open and closed positions; and
an energy storage system in fluid communication with the actuator to drive the actuator, the energy storage system including:
a single accumulator having a first chamber and a second chamber, the first chamber in fluid communication with the actuator and the second chamber in fluid communication with a pipeline to receive pressurized fluid from the pipeline; and
a pump arranged to pump hydraulic fluid into the first chamber of the single accumulator to charge the single accumulator against the pressure of the pressurized fluid in the second chamber,
the energy storage system defining:
a fully charged state, in which the first chamber of the single accumulator includes a maximum operational volume of the hydraulic fluid and the second chamber includes a minimum operational volume of the pressurized fluid, and
a fully discharged state, in which the first chamber of the single accumulator includes a minimum operational volume of the hydraulic fluid and the second chamber includes a maximum operational volume of the pressurized fluid.

17. The fluid control system of claim 16, wherein the pump is in fluid communication with the actuator and a fluid reservoir, and
wherein operation of the pump places the energy storage system in a charging state, in which the pump pumps hydraulic fluid from the fluid reservoir into the first chamber of the single accumulator.

18. The fluid control system of claim 17, wherein the pump is a manual pump that is operatable by hand without electricity.

19. The fluid control system of claim 16, wherein the energy storage defines a discharging state, in which the hydraulic fluid flows from the first chamber of the single accumulator to the actuator and pressurized fluid flows from the pipeline into the second chamber of the single accumulator.

20. The fluid control system of claim 16, further comprising a directional control valve to direct hydraulic fluid from the first chamber of the single accumulator to the actuator to move the actuator in a first direction and to direct hydraulic fluid from the first chamber of the single accumulator to the actuator to move the actuator in a second direction.

21. The fluid control system of claim 20, wherein moving the actuator in the first direction opens the valve and moving the actuator in the second direction closes the valve.

22. The fluid control system of claim 20, wherein each of (i) moving the actuator in the first direction to fully close the valve and (ii) moving the actuator in the second direction to open the valve from closed provides a respective valve event, and
wherein the single accumulator is configured to supply flow for fewer than two valve events before arriving at the fully discharged state.

23. The fluid control system of claim 20, wherein each of (i) moving the actuator in the first direction to fully close the valve and (ii) moving the actuator in the second direction to open the valve from closed provides a respective valve event, and
wherein the single accumulator is configured to provide at least three valve events before arriving at the fully discharged state.

24. The fluid control system of claim 16, wherein the hydraulic fluid is contained within a first flow system and the pressurized fluid is contained in a second flow system that is fluidically closed to the first flow system.

25. The fluid control system of claim 16, further comprising a quick connect system configured to selectively connect a portable pump in parallel with the pump, to arrange the portable pump to pump hydraulic fluid into the first chamber of the single accumulator to charge the single accumulator against the pressure of the pressurized fluid in the second chamber.

26. The fluid control system of claim 16, wherein the energy storage system permits the single accumulator to transition from the fully charged state to the fully discharged state without operation of the pump.

27. An energy storage system for driving an actuator, the actuator configured to move a valve between open and closed positions to control flow of a process fluid through a section of a pipeline, the energy storage system comprising:
a vessel defining an internal chamber in fluid communication with the actuator and with a pump, the pump configured to charge the vessel with a control fluid against pressure applied by the process fluid; and
a sensor configured to sense a fluid level of the control fluid within the vessel and signal whether the control fluid is at a maximum operational volume, the maximum operational volume being less than the total volume of the internal chamber of the vessel.

28. The energy storage system of claim 27, wherein the vessel is not arranged to operate in parallel with an accumulator.

29. The energy storage system of claim 27, further comprising:
a manual pump configured to pump hydraulic fluid into the vessel to charge the vessel against the pressure of the process fluid,
wherein operation of the manual pump places the vessel in a charging state, in which the manual pump pumps hydraulic fluid from a fluid reservoir into the vessel.

30. The energy storage system of claim 29, wherein the vessel defines a discharging state in which hydraulic fluid flow from the vessel to the actuator and pressurized process fluid flow from the pipeline into the vessel.

31. The energy storage system of claim 27, wherein the process fluid is fluidically separated from the hydraulic fluid.

32. The energy storage system of claim 31, wherein the vessel is a single accumulator.

33. A method of actuating a valve of a pipeline for a process fluid, the method comprising:
charging an accumulator, wherein charging the accumulator includes manually pumping a control fluid from a fluid reservoir to charge a first chamber of the accumulator with the control fluid,
discharging the accumulator to drive an actuator of the valve via a flow of the control fluid out of the first chamber, powered by pressure of process fluid within the pipeline.

34. The method of claim 33, wherein discharging the accumulator includes signaling the control fluid to flow from the first chamber of the accumulator to the actuator and sending a process fluid from the pipeline into a second chamber of the accumulator, and
wherein discharging the accumulator does not include operating a pump in fluid communication with the accumulator.
